(19) United States
(12) Patent Application Publication
(10) Pub. No.: US 2021/0176993 A1
(43) Pub. Date: Jun. 17, 2021

(54) INSECTICIDAL COMPOSITION CONTAINING A HYDROPHOBIC SILICA

(71) Applicant: AB7 Innovation S.A.S.U., Deyme (FR)

(72) Inventors: Arnaud VILBERT, Baziege (FR); René CHELLE, Deyme (FR); Sandrine LEVIER, Cintegabelle (FR); Aurèlien COURAUD, Toulouse (FR)

(21) Appl. No.: 17/052,689

(22) PCT Filed: May 6, 2019
(86) PCT No.: PCT/FR2019/000069

§ 371 Date: Nov. 3, 2020

(30) Foreign Application Priority Data
May 4, 2018 (FR) 1800435

(51) Int. Cl. A01N 59/00; A01N 31/02; A01N 35/02; A01N 25/22; A01N 25/12; A01N 25/06; A01N 25/04

(52) U.S. Cl. CPC A01N 59/00; A01N 31/02; A01N 35/02; A01N 25/04; A01N 25/12; A01N 25/06; A01N 25/22

(57) ABSTRACT

The present invention relates to a composition for controlling harmful arthropods, comprising at least one repellent agent and, as an insecticide, hydrophobic silica particles, characterized in that it further comprises at least a stabilizing agent of the repellent agent. According to the composition of the invention, it is permitted to protect a repellent agent from degradation in the presence of hydrophobic silica particles.

The invention relates to a composition having a concomitant repellent and insecticidal action, said composition comprising hydrophobic silica as an insecticidal component, as well as a repellent agent.

The prior art describes numerous insecticidal compositions for combating insects, particularly crawlers.

Patent application FR3049163 describes a method for combating infestations of crawling insects, particularly bedbugs, located in a delimited surveillance space. In order to implement such a method, a repellent agent consisting of geraniol and/or citronellal and an insecticidal agent are used simultaneously but within two distinct compositions. It is described that the atmospheric diffusion of the repellent agent makes it possible to flush out the pests from their hiding places. Moreover, the repellent action is complemented by a second, insecticidal action, which may be a silica. Patent application FR3049163 describes two different compositions for exercising the repellent activity and the insecticidal activity, but there is no mention anywhere of a composition that combines the two activities. In addition, no mention is made of any hydrophobic silica within a stable composition containing the repellent agent.

Patent application WO01/80645 or its equivalent, EP1276377, describes a gelled biocidal composition containing hydrophobic silica. The aerated gel composition can be sprayed like liquids using conventional spray equipment. The hydrophobic silica microparticles confer acaricidal and insecticidal activity. However, the authors recommend adding other insecticidal agents to the composition in order to increase the spectrum of biocidal activity, as well as a gelling agent in order to increase stability. The composition comprises, by weight, from 30 to 97% water, from 0.2 to 5% of a gelling agent, from 2 to 5% of hydrophobic silica microparticles treated with silicone, and from 0.004 to 20% of a biocidal agent such as hydroxycoumarin or synthetic insecticides (pyrethroids). It is indicated that, when the amount of hydrophobic silica microparticles exceeds 5% by weight, the gel becomes excessively dusty, rendering it unsuitable for use. The silica used has a particle size in the micrometric range, ideally around 40 μm. The gelled composition defined above is obtained under high shear conditions, 1500 to 6000 revolutions/min, so as to cause a fine fragmentation of the water into tiny droplets covering the hydrophobic silica microparticles. The problem described in this application is that of stabilizing the composition. The solution provided is therefore the compulsory presence of a gelling agent in order to obtain the desired stability. The possibility of obtaining a composition containing stable hydrophobic silica without a gelling agent is therefore in no way suggested.

GB1430207 describes an aqueous gel composition for the treatment of air comprising, by weight, from 89 to 95% water, from 0.23 to 2.0% of hydrophobic silica microparticles, and from 3 to 5% of a volatile active ingredient, perfume, or insecticide. Said silica is used here in a small percentage to increase the mechanical strength of the gel but also to improve the thermal stability thereof. The composition may include a surfactant that is intended to also enhance the stability of the volatile active ingredient in the aqueous medium. The composition is in the form of a gel obtained by virtue of the presence of a gelling agent of the carrageenan type. No stable composition is described which combines a repellent agent and hydrophobic silica particles of a nanometric size in a stable composition without a gelling agent.

Patent application US2008181968 describes a stable, non-toxic pesticide composition having fungicidal and insecticidal properties. Geraniol and Citronellal are cited among other essential oils. But there is no mention of the presence of insecticidal hydrophobic silicas.

The target pests of the present invention-crawling arthropods-preferably consist of crawling insects, particularly bedbugs, cockroaches, mealworms, weevils, fleas, and acarids such as ticks. Flying insects, particularly flies, mosquitoes, wasps, or hornets, could also be treated with the composition according to the invention.

Although the prior art does describe various compositions, it remains necessary to develop products that make it possible to effectively eliminate crawling arthropods and, in particular, bedbugs, or cockroaches, which are difficult to locate and remove from their housing in order to eliminate them.

The invention therefore relates to a stable composition comprising, in the presence of suitable solvents, a combination of a repellent agent and hydrophobic silica particles, said silica having the particularity of fulfilling its role of insecticide by mechanical and non-chemical action.

The composition according to the invention is intended to be applied to any type of surface, particularly walls, the floor, tiles, plastic, fabric, or a biological membrane such as the skin, in order to kill the target pests defined above.

In order for the composition to be stable and effective, it is imperative that the combined “insecticidal/repellent” effect be maintained in its functional state. In other words, each of these two elements must be able to fulfill its own function in the composition. However, the Applicant has observed that, in a composition in which these two active substances, the repellent agent degrades over time; this results in a diminishing, or even a loss, of the repellent activity vis-à-vis the targeted pests.

The invention is based on a composition within which the repellent agent is protected from the degradation that is observed in the presence of hydrophobic silica particles. The present invention therefore relates to a stable and effective composition for combating harmful arthropods comprising at least one repellent agent and one hydrophobic silica, characterized in that the silica is in the form of fine particles, and in that the composition comprises at least one stabilizer for the repellent agent.

The repellent agent is used within the composition to trigger the movement of pests even though they may be perfectly quiescent in their hiding places. Since the hydrophobic silica particles and the repellent agent are located within the same composition, they will be simultaneously distributed to the location where said pests are located, so the pests will be directly in contact with the silica particles and killed.

According to one embodiment, the repellent agent is taken from the group formed by an essential oil, monoterpene derivatives of essential oils of the type of the alcohols, aldehydes, or esters. In particular, the essential oils can be the essential oil of thyme, the essential oil of peppermint, or mixtures thereof. Preferably, the repellent agent is a monoterpene derivative such as geraniol or citronellal. Geraniol works well on most pests.

The repellent agent is present within the composition in concentrations ranging from 0.5 to 15%, preferably between 0.9 and 2.5%, by total weight of the composition.

The composition according to the invention thus comprises a hydrophobic silica as a second essential ingredient. Hydrophobic silicas were chosen because of the fact that they preserve their insecticidal activity in aqueous medium, unlike hydrophilic silicas. As is inherently known, there are many chemical treatment processes, referred to as “hydrophobization,” that make it possible to turn the hydrophilic silica particles hydrophobic. One noteworthy example is the technique of plasma polymerization. The aforementioned post-treated silica particles are thus obtained by means of a known hydrophobization process. In general, hydrophobization, which can be partial or total, is achieved, for example, by coating the hydrophilic silica particles with a thin layer of organosilicon compound, or by covalent grafting of alkylchlorosilane or polydimethylsiloxane compounds at sites located on hydrophilic silica particles. As a result, the chemical nature of the hydrophobic silica particles obtained may be different depending on the process used and/or depending on the nature of the hydrophobic compound used. Advantageously, the hydrophilic silica particles are of mineral origin.

The hydrophobic silicas according to the invention have the particularity of exhibiting insecticidal activity by direct mechanical means. By its nature and physical characteristics, hydrophobic silica kills insects by means of an abrasive and/or absorbent effect. The abrasiveness of silica induces lesions of the cuticle of insects, causing injuries and thus leading to the loss of the internal fluid of the insect and its death. At the same time, silica also acts by absorbing the fatty parts of the cuticles. The absorption of epicuticular waxes present on the surface of the cuticle decreases its tightness and induces desiccation of the insect through loss of internal fluid.

The hydrophobic silica used in the composition according to the invention is selected with a specific particle size in order to exhibit increased efficiency. In fact, the finer the particles, the greater the contact surface they will provide, resulting in increased capacity for absorption and abrasiveness. Likewise, their nanometric size allows them to be inserted and act in fine and sensitive places of the insect, such as the joints of the articulations, the mouth parts, and the stigmata.

According to one particular embodiment, and in order to increase their efficiency, the hydrophobic silica particles of the composition have an average size of between 1 nm and 20 μm, preferably between 70 and 200 nm.

The hydrophobic silica particles can be of plant or mineral origin.

According to one variant, the hydrophobic silica particles are of plant origin and can be selected from among rice silica, bamboo fibers, or mixtures thereof.

According to another variant, the hydrophobic silica particles are of mineral origin and can be selected from the group formed by 1,1,1-trimethyl-N-(trimethylsilyl) silanamine, post-treated fumed silica, post-treated diatomaceous earth, post-treated silicon dioxide, insoluble metal silicates, or mixtures thereof. According to a preferred embodiment, the hydrophobic silica used in the composition according to the invention is 1,1,1-trimethyl-N-(trimethylsilyl) silanamine, or diatomaceous earth, or a mixture thereof. The hydrophobic silica particles represent from 1 to 99%, preferably between 2 and 40%, and more preferably between 4 and 8% of the composition by total weight

According to a preferred embodiment, in order to ensure the stability of the repellent in the presence of hydrophobic silica particles, the composition according to the invention comprises a stabilizing agent for the repellent.

The stabilizing agent can be selected from among a weak base, an ether, or mixtures thereof. Surprisingly, in fact, the addition of a weak base and/or of an ether makes it possible to stabilize or even prevent the degradation of the repellent agent within the composition over time and thus to optimally preserve the repellent effect associated therewith.

According to one embodiment, the weak base can be an amine that is selected from among from triethanolamine, dihydroxypropylamine, triisopropanolamine, or mixtures thereof. The ether can be 2,5,7,10-tetraoxaundecane or a glycol ether that is selected, in particular, from among dipropylene glycol monomethyl ether, propylene glycol methyl ether, and propylene glycol ether. The stabilizing agent or agents represent between 0.5% to 35%, preferably between 2 and 10%, of the composition by total weight. Preferably, the stabilizing agents used in the composition are triethanolamine, triisopropanolamine, 2,5,7,10-tetraoxaundecane, or dipropylene glycol monomethyl ether, or mixtures thereof.

The composition according to the invention therefore comprises at least 0.5 to 15% of repellent agent, 1 to 99% of hydrophobic silica particles, and 0.5 to 35% of stabilizing agents by total weight of the composition.

The composition according to the invention can be available in various galenic forms, particularly in the form of a powder, liquid, gel, suspension, or aqueous dispersion. In order to obtain such stable and effective galenic forms, the composition therefore comprises additional ingredients such as solvents, water, inert filler, or other additives which those skilled in the art will adapt to achieve the desired result.

The composition according to the invention comprises at least one liquid solvent. The solvent component performs a plurality of functions. The liquid solvent is a distribution vector for the other constituents of the composition, ensures good dispersion of the hydrophobic silica particles, makes it possible to customize the viscosity of the composition, and/or it can be a diluent for the repellent agent. Said solvent is an aqueous solvent and/or a non-aqueous solvent that is miscible with water. The solvent(s) will be selected so as to obtain a homogeneous mixture of the various ingredients of the composition. In particular, the solvent is selected in a non-limiting manner from among ethers, alcohols, ketones, carbonates, or mixtures thereof. Advantageously, the solvent is selected from among ethanol, propanol, isopropanol, acetone, methyl ethyl ketone, methyl propyl ketone, methyl butyl ketone, propylene carbonate, ethers such as 2,5,7,10-tetraoxaundecane, or glycol ethers that are selected in particular from among dipropylene glycol monomethyl ether, propylene glycol methyl ether, and propylene glycol ether, or a mixture of these solvents. In a particularly preferred embodiment, when 2,5,7,10-retraoxaundecane, dipropylene glycol monomethyl ether, propylene glycol methyl ether, propylene glycol ether, or a mixture thereof is used, an alcohol-type solvent is added.

The composition according to the invention also advantageously contains water in addition to the solvent. The water serves primarily as a distribution vector and also ensures the link between the hydrophobic silica particles and the miscible non-aqueous solvent(s). It has been observed that the establishment of this link makes it possible, on the one hand, to make these two entities compatible with one another (silica particles and miscible non-aqueous solvent) and, on the other hand, to facilitate the subsequent implementation of an aqueous dispersion.

The nature, number, and proportions of the solvent in the composition will be adapted to the type of galenic formulation of the composition according to the invention.

According to one embodiment, the composition can be in the form of a powder. Advantageously, this embodiment of the invention makes it possible to distribute the composition directly, particularly by means of a powder device.

In the case of a composition in powder form, the composition therefore comprises the repellent agent, the hydrophobic silicone particles, the stabilizing agent for the repellent agent, the solvent—here diluent for the repellent agent—and a solid filler. Said solid filler is an inert powder that is selected from the group formed by talc, alumina, feldspar, calcium carbonate, dolomite, calcium silicate, clay, and mixtures thereof. The term “inert powder” means that it has no substantial insecticidal action in relation to the target pests. In the case of a composition according to the invention in powder form, the manufacturing method consists, as a first step, in mixing the inert powders and hydrophobic silicas. The repellent—previously diluted in a solvent—is then sprayed onto the mixture of powders. It is then absorbed and adsorbed on the various powders of the composition. The composition in powder form therefore comprises a non-aqueous liquid solvent for the repellent agent that preferably represents 4 to 10% by weight of the composition. In a particular case according to the invention, the solvent is also a stabilizer for the repellent agent.

A powder-type composition according to the invention therefore comprises at least 0.5 to 15% of repellent agent, 1 to 99% of hydrophobic silica particles, and 0.5 to 35% of stabilizing agents, and 0 to 80% of inert powder, the percentages being expressed by total weight of the composition.

According to another embodiment, the composition is in liquid form and comprises the repellent agent, the hydrophobic silicone particles, the stabilizing agent for the repellent agent, the liquid solvent and, optionally, water. Said liquid solvent is an aqueous and/or non-aqueous solvent that is miscible with water selected from among the solvents listed above. In such a case, the composition comprises at least 0.5 to 15% of repellent agent, 1 to 99% of hydrophobic silica particles, and 0.5 to 35% of stabilizing agents, and 10 to 80% of solvent, the percentages being expressed by total weight of the composition.

In a preferred embodiment, the liquid form is sprayable so as to enable distribution of the composition particularly by means of an aerosol. The composition consists of a powder, said powder being dispersed in a liquid solvent which makes it compatible with a propellant gas for dispensing the composition as an aerosol. In such a case, the liquid solvent represents from 10 to 80% by weight of the composition without the propellant gas.

According to another particularly preferred embodiment, the composition is in the form of a gel. Surprisingly, in fact, by virtue of its ingredients and, in particular, the hydrophobic silica, the composition constitutes a composition in the form of a gel even in the absence of an organic gelling agent. The composition can have a viscosity of between 5 and 250 poise at room temperature. The intrinsic viscosity of the composition according to the invention allows better contact with pests. Such a composition according to the invention also has the advantage of being sufficiently viscous as to remain localized on the areas to be treated against pests, even and especially in the absence of additional gelling agent. The Applicant has also shown that, surprisingly, the addition of a gelling agent or thickener acts counter to the insecticidal efficacy of the composition. One of the essential characteristics of the composition according to the invention is therefore that it does not contain any gelling agent or thickeners.

According to a preferred embodiment according to the invention, the composition in liquid or gel form therefore comprises, relative to the weight of the total composition:
from 2 to 25% by weight of finely particulate hydrophobic silica(s),
from 0.5 to 10% by weight of repellent agent(s),
from 0.5 to 10% by weight of weak base(s),
the remainder to 100% by weight being constituted by the liquid solvent and/or water.

More preferably, when 2,5,7,10-tetraoxaundecane, dipropylene glycol monomethyl ether, or propylene glycol ether are used as solvent, either alone or in admixture, they can represent from 35 to 75% by weight of the gel, preferably from 40 to 70%, and are used in the presence of alcohol at 2 to 10% by weight. Advantageously, the aqueous solvent can represent from 10 to 30% by weight of the gel.

According to a preferred embodiment according to the invention, the composition in liquid or gel form comprises:
from 4 to 8% by weight of finely particulate hydrophobic silica(s),
from 0.9 to 2.5% by weight of repellent agent(s),
from 0.8 to 5% by weight of weak base(s),
from 22 to 50% by weight of solvent
from 30 to 80% water.

According to a particular preferred embodiment, the composition in liquid or gel form comprises:
from 4 to 8% by weight of finely particulate hydrophobic silica(s), selected from among 1,1,1-trimethyl-N-(trimethylsilyl) silanamine or diatomaceous earth or a mixture thereof.
from 0.9 to 2.5% by weight of repellent agent(s), selected from among geraniol or citronellal or a mixture thereof
from 0.8 to 5% by weight of weak base(s), selected from among amines.
from 22 to 50% by weight of solvent, selected from among 2,5,7,10-tetraoxaundecane, dipropylene glycol monomethyl ether, propylene glycol ether, ethanol, or a mixture thereof
from 30 to 80% water.

Advantageously, the pH of the composition in liquid or gel form is between 7.5 and 10, preferably between 8.8 and 9.5.

According to one embodiment, the composition constitutes an aqueous dispersion that is obtained by diluting a gel as defined above by adding to it from 40 to 75% by weight of an aqueous solvent, and preferably softened water. The dilution is defined so as to obtain the correct viscosity and to facilitate spraying of the composition at the nozzle outlet. Advantageously, the aqueous dispersion is distributed by means of a manual nozzle sprayer operating under a pressure of between 3 and 5 bar.

The spray system that is used for dispensing the aqueous dispersion may include a reservoir, an outlet nozzle, and a manually actuated trigger. Inside the tank, a screen can be provided which is disposed in front of the outlet nozzle in order to prevent aggregates of particles from clogging the nozzle.

The compositions according to the invention exhibit good physical and chemical stability. “Physical stability” means the maintenance of the integrity of the composition in terms of homogeneity. No settling or phase shift must be observed, even when subjected to different temperatures, over time. “Chemical stability” refers, in particular, to the stability of the active substances and, in the case of the compositions according to the invention, the stability of the repellent agent. Said repellent agent must not exhibit any sign of degradation under the storage conditions of the composition over time and at different temperatures. Which would impact the effectiveness of the composition.

As a non-limiting example of the stability test conditions, the compositions can be analyzed (physical and chemical parameters) at T0, after 2 weeks, and after 6 months at different temperatures—particularly at room temperature, at 40° C., and/or at 54° C.

The present invention relates to a method for killing harmful insects using the composition according to the invention.

The present invention therefore relates to a method for eliminating insects and, more precisely, crawling insects of the bedbug or cockroach type, which consists in bringing the pests into contact with an insecticidal composition that combines a repellent agent and fine particles of hydrophobic silica.

The method is carried out in two stages: the composition according to the invention is applied to the areas to be treated. First, the repellent present in the composition triggers the movement of the pests out of their housing. Consequently, the pests will subsequently be in contact with the composition and, in particular, the hydrophobic silica particles, which will cause them to dry out and die.

The present invention therefore relates to the various embodiments presented in the following list:

The invention relates to a stable composition for combating harmful arthropods comprising at least particles of hydrophobic silica and a repellent agent taken from the group formed by essential oils or monoterpene derivatives of essential oils of the type of the alcohols, aldehydes, or esters, characterized in that the composition further comprises at least one stabilizing agent for the repellent agent that is selected from among a weak base, an ether, or mixtures thereof.

The invention relates to a composition which is characterized in that the repellent agent is geraniol, citronellal, or a mixture thereof.

The invention relates to a composition which is characterized in that the weak base is an amine that is selected from among triethanolamine, dihydroxypropylamine, and triisopropanolamine.

The invention relates to a composition which is characterized in that the ether is a glycol ether that is selected from 2,5,7,10-tetraoxaundecane, dipropylene glycol monomethyl ether, propylene glycol methyl ether, and propylene glycol ether.

The invention relates to a composition which is characterized in that the hydrophobic silica particles have an average size of between 70 nm and 200 nm.

The invention relates to a composition which is characterized in that the hydrophobic silica particles are mineral in nature and selected from the group formed by 1,1,1-trimethyl-N-(trimethylsilyl) silanamine, post-treated fumed silica, post-treated diatomaceous earth, post-treated silicon dioxide, insoluble metal silicates, or mixtures thereof.

The invention relates to a composition which is characterized in that it comprises at least 0.5 to 15% of repellent agent, 1 to 99% of hydrophobic silica particles, and 0.5 to 35% of stabilizing agents by total weight of the composition.

The invention relates to a composition which is characterized in that it further comprises an aqueous solvent or a non-aqueous solvent that is miscible with water that is selected from among ethers, glycol ethers, alcohols, ketones, carbonates, or mixtures thereof.

The invention relates to a composition which is characterized in that the solvent is ethanol, propanol, isopropanol, acetone, methyl ethyl ketone, methyl propyl ketone, methyl butyl ketone, propylene carbonate, 2,5,7,10-tetraoxaundecane, dipropylene glycol monomethyl ether, propylene glycol methyl ether, and propylene glycol ether, either alone or in admixture.

The invention relates to a composition which is characterized in that the solvent is ethanol and 2,5,7,10-tetraoxaundecane or dipropylene glycol monomethyl ether.

The invention relates to a composition which is characterized in that it is in the form of powder, liquid, gel, suspension, or aqueous dispersion.

The invention relates to a composition which is characterized in that it is in powder form and further comprises a solid filler which supplements the composition to 100% by weight, said solid filler being an inert powder that is selected from the group formed by talc, alumina, feldspar, calcium carbonate, dolomite, calcium silicate, and mixtures thereof.

The invention relates to a composition which is characterized in that it constitutes a liquid comprising a powder that is dispersed in a liquid solvent, said solvent compatibilizing the powder with a propellant gas.

The invention relates to a composition which is characterized in that the liquid solvent represents from 10 to 80% by weight of the composition without the propellant gas.

The invention relates to a composition which is characterized in that it is dispensed by means of an aerosol.

The invention relates to a composition which is characterized in that it constitutes a gel that is devoid of organic gelling agent.

The invention relates to a composition which is characterized in that it constitutes a gel having a viscosity of between 5 and 250 poise at room temperature, said composition comprising, relative to the weight of the total composition:
from 2 to 25% by weight of finely particulate hydrophobic silica(s);
from 0.5 to 10% by weight of repellent agent(s);
from 0.5 to 10% by weight of weak base(s);
the remainder to 100% by weight being constituted by a liquid solvent.

The invention relates to a composition which is characterized in that it constitutes an aqueous dispersion that is obtained by diluting a gel according to claim 17 by adding to it from 40 to 75% by weight of an aqueous solvent.

The invention relates to a composition which is characterized in that it constitutes a gel or a liquid comprising:
from 4 to 8% by weight of finely particulate hydrophobic silica(s),
from 0.9 to 2.5% by weight of repellent agent(s),
from 0.8 to 5% by weight of weak base(s),
from 22 to 50% by weight of solvent
from 30 to 80% water.

The invention relates to a composition which is characterized in that the pH of the composition is between 7.5 and 10, preferably between 8.8 and 9.5.

The invention also relates to the use of the composition according to the invention for eliminating harmful insects.

The invention relates to the use of the composition according to the invention for eliminating harmful flying insects such as flies, mosquitoes, bugs, wasps, hornets.

The invention preferably relates to the use of the composition according to the invention for eliminating harmful crawling insects such as bedbugs, cockroaches, mealworms, weevils, fleas, and acarids such as ticks.

The invention also relates to a method for killing harmful insects which is characterized in that it uses a composition according to the invention.

The invention relates to a method which is characterized in that the harmful insects are crawling insects selected from among bedbugs or cockroaches.

The invention relates to a method which is characterized in that it comprises the following steps:

a. The composition is applied to the areas to be treated,

b. the repellent agent present in the composition triggers the movement of pests out of their housing,

c. the pests are brought into contact with the hydrophobic silica particles of the composition, causing their death.

### LIST OF FIGURES

FIG. 1 Progression of the geraniol content in a composition in powder form.

FIG. 2 Progression of the mortality of bedbugs treated with an aqueous dispersion that is obtained from a gel.

FIG. 3 Progression of the mortality of bedbugs treated with compositions A and B without and with gelling agent.

The non-limiting examples which follow serve only to illustrate the invention without restricting its scope.

### Example 1: Study of the Stability of Geraniol in an Insecticidal Powder Composition According to the Invention

The insecticidal composition according to the invention corresponds to the following formulation, hereinafter referred to as “ZIF-77,” containing Geraniol as a repellent active ingredient in the presence of a stabilizing agent. It comes in the form of a powder. It is tested against a reference composition, “ZIF-78,” the composition of which is given in Table 1 below. Note that the only difference between the two compositions is the presence of stabilizing agent in the composition according to the invention. “ZIF-77.”

| Composition | | ZIF-77 | ZIF-78 |
|---|---|---|---|
| Component | Function | Quantity (g) | Quantity (g) |
| Hydrophobic silica | insecticide | 85 | 90 |
| Triethanolamine | stabilizing | 5 | 0 |
| Geraniol | repellent | 10 | 10 |

The degradation of the geraniol contained in the compositions was quantified by chromatographic assay, more precisely by internal calibration of the geraniol in gas-phase chromatography (CGP). FIG. 1 shows the degradation of the geraniol in the compositions over time.

Note that the composition “ZIF-77,” which contains triethanolamine as stabilizing agent, makes it possible to keep the geraniol stable for at least 35 days, whereas a degradation of the geraniol is observed within the reference composition, “ZIF-78,” which does not comprise a stabilizing agent.

The observation, which was continued for 3 months, shows that the geraniol in composition “ZIF-77” remains stable; its profile (not shown) is almost identical to that shown in FIG. 1.

### Example 2: Preparation of an Insecticidal Gel According to the Invention

Liquid solvents consisting of 478 g of 2,5,7,10-tetraoxaundecane and 50 g of ethanol are introduced into a tank equipped with a shear blade with a volume of 2 L. The mixture is stirred lightly until a homogeneous liquid mixture is obtained.

80 g of hydrophobic silica powder are introduced into the above liquid mixture, whereupon the whole mixture is stirred vigorously at 1400 revolutions/min until a homogeneous mixture is obtained which constitutes a thick paste.

50 g of triisopropanolamine as well as 318 g of softened water are added to the thick paste obtained above; then the whole mixture is stirred moderately until homogenized in order to obtain a neutralized insecticidal gel.

Finally, 12 g of geraniol and 12 g of citronellal are added to the neutralized insecticidal gel obtained above in order to obtain an insecticidal gel according to the invention.

The insecticidal gel—hereinafter called “ZIDIF-102C1”—thus comprises:
47.8% by weight of 2,5,7,10-tetraoxaundecane,
5% by weight of ethanol,
8% by weight of hydrophobic silica particles,
1.2% by weight of geraniol,
1.2% citronellal,
31.8% by weight of softened water from the network,
5% by weight of triisopropanolamine.

The characteristics of “ZIDIF-102C1” insecticidal gel are:
Homogeneous appearance, not “dusty”
pH: 9.09
viscosity measured with a no. br62 Brookfield viscometer needle at room temperature (20 to 23° C.) for 10 revolutions/min at T0 (i.e., at the end of preparation): 9664 centipoise
density: 1.05
dry extract rate: 92%

### Example 3: Composition According to the Invention in the Form of an Aqueous Dispersion

The aqueous dispersion is obtained by diluting the aforementioned “ZIDIF-102C1” gel by adding 50% by weight of tap water. Said aqueous dispersion therefore comprises:
23.9% by weight of 2,5,7,10-retraoxaundecane,
2.5% by weight of ethanol,
4% by weight of hydrophobic silica particles,
0.6% by weight of geraniol,
0.6% of citronellal,
65.9% by weight of water,
2.5% by weight of triisopropanolamine.

The aqueous dispersion obtained above is conditioned in a nozzle sprayer that is pressurized to 4 bar.

### Example 4: Progression of the Mortality of Bedbugs and Cockroaches Treated with the Aqueous Dispersion Obtained in Example 3 Above

The effectiveness of the composition was tested on bedbugs (Cimex lectularius) and cockroaches (Blatella germanica). Bedbugs are known to be vectors of disease transmission in Europe; moreover, their infestations can also cause pain and irritation on the skin in humans, for example.

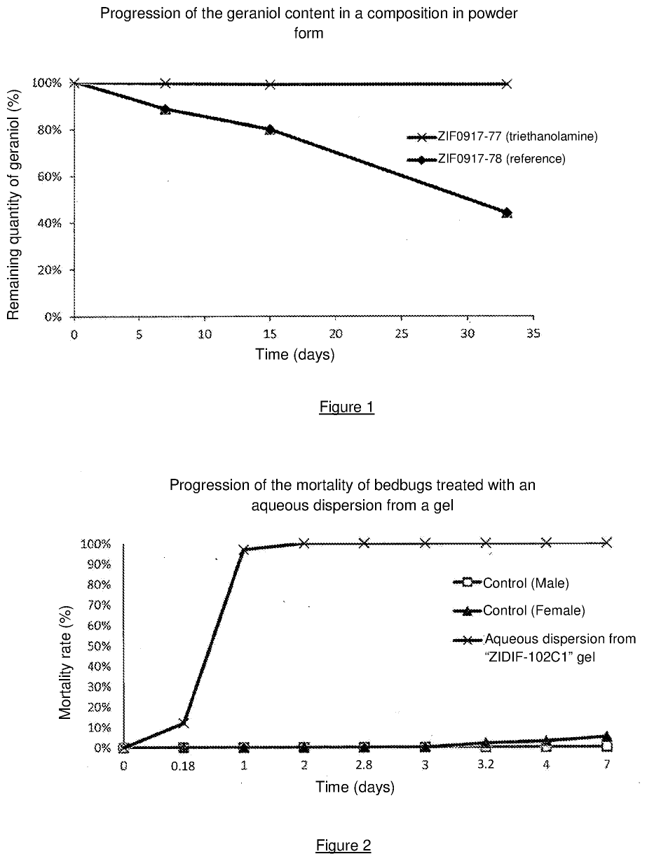

After stirring, 1 liter of the abovementioned dispersion is sprayed onto a surface of 10 m² to be treated—i.e., a quantity of silica particles of 4 g/m² of surface to be treated. FIG. 2 shows the insecticidal effect of aqueous dispersion “ZIDIF-102C1” containing hydrophobic silica according to the invention on the bedbugs treated.

Test on bedbugs: the tests were carried out in accordance with the guidelines of the “Transitional guide on the evaluation of the efficacy of TP18 products, insecticides, acaricides, and other biocidal products against arthropods and of TP719 products, repellents, and attractants”—ECHA, September 2016. The tests were carried out at 22° C.±2° C.

Male and female bedbugs numbering 60 individuals divided into 3 cohorts of 20 individuals each were then used as control. These individuals were fed properly in accordance with the relevant rules before the start of the test.

60 bedbugs, distributed in 3 cohorts of 20 individuals each (30 males and 30 females), are used to test the insecticidal effect of the dispersion according to the invention. It is observed that the bedbugs begin to exhibit agitation because of the repellent effect of the geraniol and citronellal; 97% of them are killed in less than 24 hours, whereas the bedbugs used as a “control” are still alive at 72 hours. After 48 hours, all bedbugs are killed by the aqueous dispersion.

Cockroach test: the procedure is the same as for bedbugs. It is observed that all the cockroaches are killed in less than 48 hours, whereas the individuals acting as a “control” survive for at least 5 days.

### Example 5: Preparation of an Insecticidal Gel G1 According to the Invention

The same procedure as in Example 2 is followed in order to produce gel G1 of the following composition
42% by weight of dipropylene glycol monomethyl ether,
5% by weight of ethanol,
8% by weight of hydrophobic silica particles,
1.2% by weight of geraniol,
1.2% citronellal,
37.6% by weight of softened water from the network,
5% by weight of triisopropanolamine.

The composition was subjected to different temperature and time conditions in order to assess its stability. The evaluation was carried out at T0, after 2 weeks at 54° C., after 6 months at 40° C. At each reading, the composition exhibited a homogeneous appearance, with no phase shift or settling. The dosage of geraniol remained within the control specifications.

### Example 6: Preparation of an Insecticidal Gel G2 According to the Invention

The same procedure as in Example 2 is followed in order to produce gel G2 of the following composition
40% by weight of dipropylene glycol monomethyl ether,
4.9% by weight of ethanol,
8% by weight of hydrophobic silica particles,
1.9% by weight of geraniol,
43.6% by weight of softened rap water,
1.6% by weight of triethanolamine.

The composition was subjected to different temperature and time conditions in order to assess its stability. The evaluation was carried out at T0, after 2 weeks at 54° C., after 6 months at 40° C. At each reading, the composition exhibited a homogeneous appearance, with no phase shift or settling. The dosage of geraniol remained within the control specifications.

The composition according to the invention therefore exhibits good chemical and physical stability.

### Example 7: Preparation of an Aqueous Dispersion D3 According to the Invention

The aqueous dispersion is obtained by diluting the gel G2 obtained in Example 6 by adding 50% by weight of softened water. Said aqueous dispersion therefore comprises:
20% by weight of 2-methoxymethylethoxypropanol,
2.45% by weight of ethanol,
4% by weight of hydrophobic silica particles,
0.95% by weight of geraniol,
71.8% by weight of softened rap water,
0.8% by weight of triethanolamine

The composition was subjected to different temperature and time conditions in order to assess its stability. The evaluation was carried out at T0, after 2 weeks at 54° C., after 6 months at 40° C. At each reading, the composition exhibited a homogeneous appearance, with no phase shift or settling. The dosage of geraniol remained within the control specifications.

The composition according to the invention therefore exhibits good chemical and physical stability. It comes in liquid form and can be packaged in a nozzle sprayer

### Example 8: Preparation of a Composition in the Form of Powder P1 According to the Invention

The powder has the following composition:
30% by weight of diatomaceous earth,
10% by weight of hydrophobic silica particles,
5% by weight of hydrophilic fumed silica
45.2% by weight of clay
1% geraniol
8.8% by weight of 2,5,7,10-tetraoxaundecane

It is prepared as follows: first, we mix the clay, diatomaceous earth, and silicas. Furthermore, the geraniol is diluted in tetraoxaundecane. This solvent/repellent mixture is then sprayed onto the mixture of powders.

The powder obtained exhibits good chemical and physical stability over time.

### Example 9: Comparative Test of Compositions According to the Invention with and without Gelling Agent

The following compositions according to the invention were produced with and without gelling agent in order to study the influence of the latter on the effectiveness of the composition.

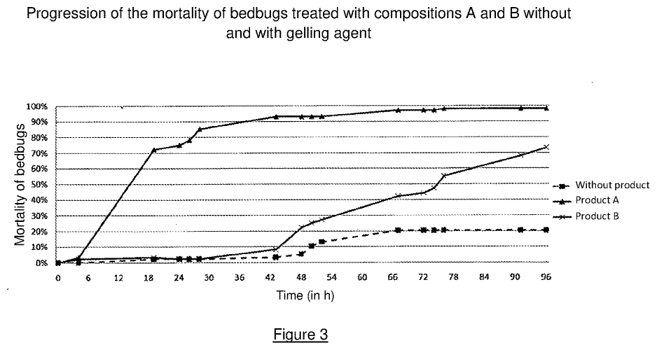

FIG. 3 shows the mortality of bedbugs as a function of time under the conditions of treatment with compositions A and B. The “without product” curve indicates the “normal” mortality of the bedbugs under the test conditions in the absence of treatment.

Formula of Product A without gelling agent:
40% by weight of dipropylene glycol monomethyl ether
4.9% by weight of ethanol,
8% by weight of hydrophobic silica particles,
1.9% by weight of geraniol,
1.6% by weight of an amine.
43.6% by weight of softened tap water,

Formula of Product B=product A with gelling agent:
40% by weight of dipropylene glycol monomethyl ether
4.9% by weight of ethanol,
8% by weight of hydrophobic silica particles,
1.9% by weight of geraniol,
1.6% by weight of an amine.
0.1% xanthan gum as a gelling agent.
43.5% by weight of softened tap water,

FIG. 3 clearly shows that the addition of a gelling agent decreases the insecticidal effectiveness of the composition.

Unlike the prior art, which indicates the necessity to have a gelling agent in the composition in order to obtain a stable and effective composition, the Applicant has demonstrated that the compositions according to the invention exhibited very good chemical and physical stability as well as efficacy in the treatment of crawling pests, even and especially in the absence of additional gelling agents or thickeners.

1. A stable composition for combating harmful arthropods, comprising at least particles of hydrophobic silica and a repellent agent, taken from the group formed by essential oils or monoterpene derivatives of essential oils of the alcohols, aldehydes or esters type, characterized in that the composition further comprises at least one stabilizing agent for the repellent agent, selected from among a weak base, an ether or mixtures thereof.

2. The composition according to claim 1, characterized in that the repellent agent is geraniol, citronellal, or a mixture thereof.

3. The composition according to claim 1, characterized in that the weak base is an amine selected from among triethanolamine, dihydroxypropylamine, and triisopropanolamine.

4. The composition according to claim 1, characterized in that the ether is a glycol ether selected from among 2,5,7,10-tetraoxaundecane, dipropylene glycol monomethyl ether, propylene glycol methyl ether, and propylene glycol ether.

5. The composition according to claim 1, characterized in that the hydrophobic silica particles have an average size of between 70 nm and 200 nm.

6. The composition according to one of claims 1 to 5, characterized in that the hydrophobic silica particles are mineral in nature and selected from the group formed by 1,1,1-trimethyl-N-(trimethylsilyl) silanamine, silica post-treated pyrogen, post-treated diatomaceous earth, post-treated silicon dioxide, insoluble metal silicates, or mixtures thereof.

7. The composition according to one of claims 1 to 6, characterized in that it comprises at least 0.5 to 15% of repellent agent, 1 to 99% of hydrophobic silica particles, and 0.5 to 35% of stabilizing agents by total weight of the composition.

8. The composition according to one of claims 1 to 7, characterized in that it further comprises an aqueous solvent or a non-aqueous solvent that is miscible with water selected from among ethers, glycol ethers, alcohols, ketones, carbonates, or mixtures thereof.

9. The composition according to claim 8, characterized in that the solvent is ethanol, propanol, isopropanol, acetone, methyl ethyl ketone, methyl propyl ketone, methyl butyl ketone, propylene carbonate, 2,5,7,10-tetraoxaundecane, dipropylene glycol monomethyl ether, propylene glycol methyl ether, and propylene glycol ether, either alone or in admixture.

10. The composition according to claim 9, characterized in that the solvent is ethanol and 2,5,7,10-tetraoxaundecane or dipropylene glycol monomethyl ether.

11. The composition according to one of claims 1 to 10, characterized in that it is provided in the form of a powder, liquid, gel, suspension, or aqueous dispersion.

12. The composition according to one of claims 1 to 11, characterized in that it is in the form of a powder and further comprises a solid filler which supplements the composition to 100% by weight, said solid filler being an inert powder that is selected from the group formed by talc, alumina, feldspar, calcium carbonate, dolomite, calcium silicate, and mixtures thereof.

13. The composition according to one of claims 1 to 10, characterized in that it constitutes a liquid comprising a powder that is dispersed in a liquid solvent, said solvent compatibilizing the powder with a propellant gas.

14. The composition according to claim 12, characterized in that the liquid solvent represents from 10 to 80% by weight of the composition, without the propellant gas.

15. The composition according to claims 13 and 14, characterized in that it is dispensed by means of an aerosol.

16. The composition according to one of claims 1 to 11, characterized in that it constitutes a gel that is devoid of organic gelling agent.

17. The composition according to one of claims 1 to 11 and 16, characterized in that it constitutes a gel having a viscosity of between 5 and 250 poise at room temperature, said composition comprising, relative to the weight of the total composition:
from 2 to 25% by weight of finely particulate hydrophobic silica(s);
from 0.5 to 10% by weight of repellent agent(s);
from 0.5 to 10% by weight of weak base(s);
the remainder to 100% by weight being constituted by a liquid solvent.

18. The composition according to claim 17, characterized in that it constitutes an aqueous dispersion that is obtained by diluting a gel according to claim 17 by adding to it from 40 to 75% by weight of an aqueous solvent.

19. The composition according to one of claims 1 to 11 and 16 to 18, characterized in that it constitutes a gel or a liquid comprising:
from 4 to 8% by weight of finely particulate hydrophobic silica(s),
from 0.9 to 2.5% by weight of repellent agent(s),
from 0.8 to 5% by weight of weak base(s),
from 22 to 50% by weight of solvent
from 30 to 80% water.

20. The composition according to one of claims 1 to 11 and 16 to 19, characterized in that the pH of the composition is between 7.5 and 10, preferably between 8.8 and 9.5.

21. A method for killing harmful insects, characterized in that it uses a composition according to one of claims 1 to 20.

22. The method according to claim 21, characterized in that the harmful insects are crawling insects selected from among bedbugs or cockroaches.

23. The method according to one of claims 21 or 22, characterized in that it comprises the following steps:
a. The composition is applied to the areas to be treated,
b. the repellent agent present in the composition triggers the movement of pests out of their housing,
c. the pests are brought into contact with the hydrophobic silica particles of composition, causing their death.
